(19) United States
(12) Patent Application Publication
(10) Pub. No.: US 2021/0241348 A1
(43) Pub. Date: Aug. 5, 2021

(54) AUTOMATICALLY EXPANDING A CURATED COLLECTION OF ITEMS

(71) Applicant: Walmart Apollo, LLC, Bentonville, AR (US)

(72) Inventors: Omer Ovenc, San Jose, CA (US); Behzad Ahmadi, San Jose, CA (US); Haider Syed, Santa Clara, CA (US); Anne Angelina Bollarapu, San Jose, CA (US); Anthony Soohoo, Palo Alto, CA (US); Harman Kochar, San Mateo, CA (US)

(73) Assignee: Walmart Apollo, LLC, Bentonville, AR (US)

(21) Appl. No.: 16/779,500

(22) Filed: Jan. 31, 2020

(51) Int. Cl. G06Q 30/06

(52) U.S. Cl. CPC G06Q 30/0631; G06Q 30/0643

(57) ABSTRACT

A method including a collection expanding model for expanding a collection of items. The method can include upon receiving a user request from a user via a user device through a network, retrieving a target collection of one or more collections from a database. The target collection can comprise collection items, one or more collection styles, and one or more collection colors. The method also can include determining candidate items for the target collection based at least in part on the collection items of the target collection. The candidate items can comprise one or more complementary candidate items or one or more substitute candidate items. The method further can include removing a first candidate item of the candidate items from the candidate items when at least a dominant style of the first candidate item is not included in the one or more collection styles and/or when at least a dominant color of the first candidate item is not included in the one or more collection colors. The method additionally can include adding the candidate items to the target collection. After the target collection is expanded by adding the candidate items, the method can include transmitting, through the network, the target collection to be presented to the user via the user device. Other embodiments are disclosed.

### TECHNICAL FIELD

This disclosure relates generally to automatically expanding a curated collection of items.

### BACKGROUND

Online retailers generally promote their products by various marketing techniques. Content curation is an effective tool to engage followers and to promote curated collections of products in an inconspicuous way. However, in order to grow followers, constant creation of new content can be desired. Additionally, content curation for marketing involves comprehensive knowledge of products offered. For retailers whose product catalogs include a large quantity of products and grow constantly by adding hundreds, if not thousands, of new products per year, it is impractical to use human curators to keep up with the products, new or old, in the catalogs and post new curations frequently.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically expanding a curated collection of items, according to an embodiment;

FIG. 4 illustrates a flow chart for a method of automatically expanding a target collection with collection items, according to an embodiment;

FIG. 5 illustrates a flow chart for a block of determining one or more complementary items as candidate items for expanding the target collection, according to the embodiment of FIG. 4; and

FIG. 6 illustrates a flow chart for a block of determining one or more substitute items as candidate items for expanding the target collection, according to the embodiment of FIG. 4.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

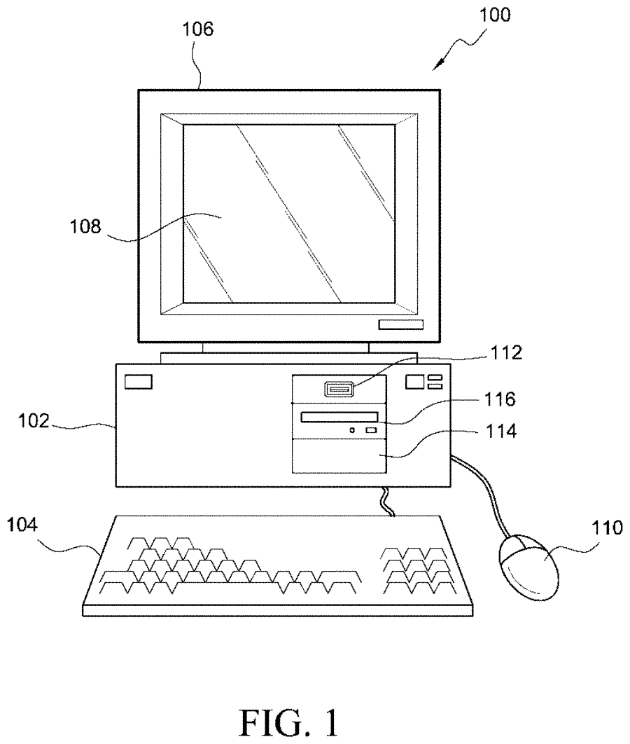

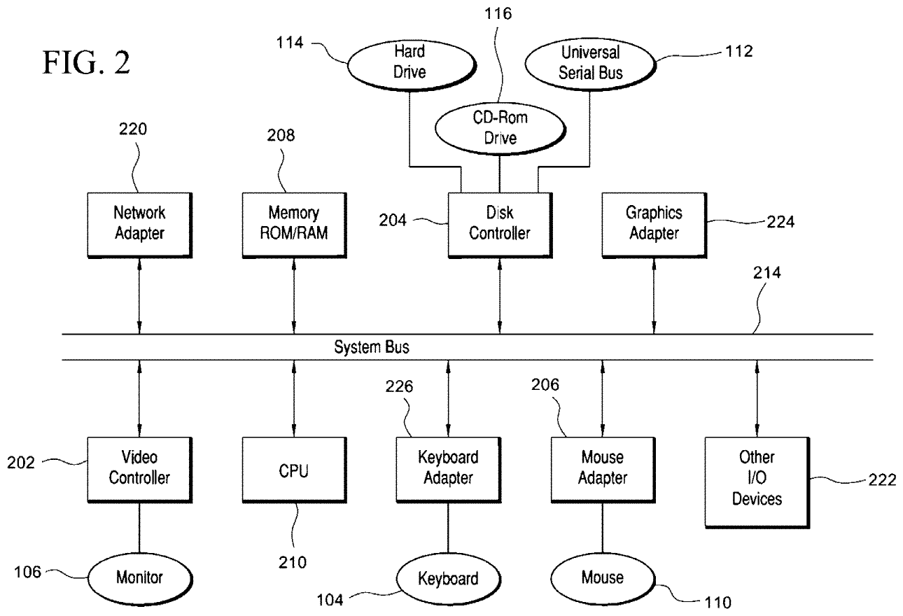

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

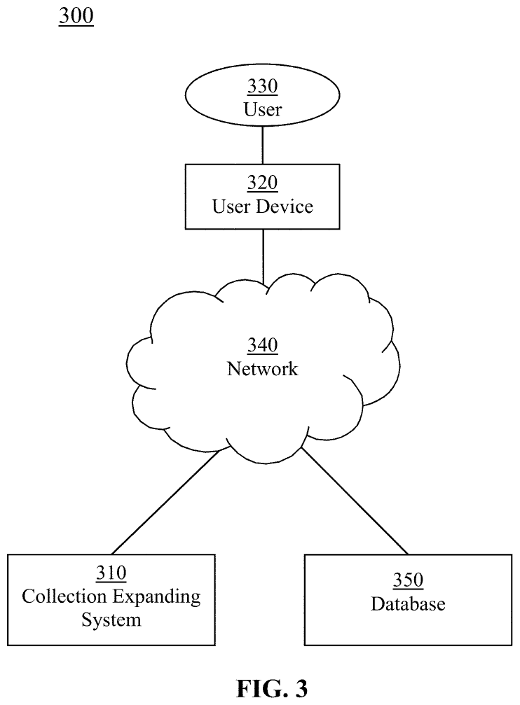

Turning ahead in the drawings, FIG. 3 illustrates a block diagram of a system 300 that can be employed for automatically expanding a curated collection of items, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems or subsystems, such as a collection expanding system 310, and/or one or more user devices, such as a user device 320. System 300, collection expanding system 310, and/or user device 320 each can be a computer system, such as computer system 100 (FIG. 1), as described above, and can each be a single computer, a single server, or a cluster or collection of computers or servers, or a cloud of computers or servers. In another embodiment, a single computer system can host each of system 300, collection expanding system 310, and/or user device 320. In many embodiments, system 300 and/or collection expanding system 310 each can be modules of computing instructions (e.g., software modules) stored at non-transitory computer readable media that operate on one or more processors. In other embodiments, system 300 and/or collection expanding system 310 each can be implemented in hardware. In many embodiments, system 300 and/or collection expanding system 310 each can comprise one or more systems, subsystems, modules, or servers. Additional details regarding system 300, collection expanding system 310, and/or user device 320 are described herein.

In some embodiments, collection expanding system 310 can be in data communication, through a computer network (e.g., network 340), with user device 320. In some embodiments, user device 320 can be used by users, such as user 330. In a number of embodiments, collection expanding system 310 can host one or more websites and/or mobile application servers. For example, collection expanding system 310 can host a website, or provide a server that interfaces with an application (e.g., a mobile application or a web browser), on user device 320, which can allow users 330 to create, update, and/or delete one or more curated collections of items. In many embodiments, the curated collections each can comprise items of similar or complementary attributes, such as styles or colors. For example, a curated collection for living room furniture can include furniture items (e.g., couches, chairs, coffee tables, side tables, etc.), each having similar or complementary colors, styles, materials, shapes, patterns, and so forth.

In some embodiments, an internal network (e.g., network 340) that is not open to the public can be used for communications between collection expanding system 310 and user device 320 within system 300. Accordingly, in some embodiments, system 300 and/or collection expanding system 310 (and/or the software used by such systems) can be operated by an operator and/or administrator of system 300 and/or collection expanding system 310. In these or other embodiments, the operator and/or administrator of system 300 and/or collection expanding system 310 can manage system 300 and/or collection expanding system 310, the processor(s) of system 300 and/or collection expanding system 310, and/or the memory storage unit(s) of system 300 and/or collection expanding system 310 using the input device(s) and/or display device(s) of system 300 and/or collection expanding system 310.

In certain embodiments, the user devices (e.g., user device 320) can be desktop computers, laptop computers, a mobile device, and/or other endpoint devices used by one or more users (e.g., users 330). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 300 and/or collection expanding system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300 and/or collection expanding system 310. In a similar manner, the processors and/or the non-transitory computer-readable media can be local and/or remote to each other.

Meanwhile, in many embodiments, system 300 and/or collection expanding system 310 also can be configured to communicate with one or more databases, such as a database 350. The one or more databases can include an item database that contains information about products, items, or SKUs (stock keeping units), for example, including item types, concept and/or attribute names, and concept and/or attribute values, among other information, as described below in further detail. The item database further can include information about item types, such as items associated with their corresponding item types, one or more respective item-type concepts for each item type, a respective relationship between two or more item types, etc. For instance, an item type of furniture can be associated with a limited number of concepts (e.g., shapes, colors, styles, materials, patterns, and upholstery, etc.). Each concept for an item type can be associated with a limited number of values. For examples, the concept of color can be associated with 10, 20, or 30, etc. predefined color groups.

The item database also can include information about the one or more collections, such as items in the corresponding collections, one or more collection styles, one or more collection colors, revision histories, etc. The one or more databases further can include a transaction database that contains information associated with the items in the item database, including acts associated with the items by one or more consumers, such as acts associated a single item (e.g., viewing, adding to cart, adding to favorites, purchasing, etc.) or acts associated with two or more items (e.g., view-also-viewed acts, view-ultimately-bought acts, and so forth), as described below in further detail.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases (e.g., database 350) can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, collection expanding system 310, the one or more user devices (e.g., user device 320), and/or the one or more databases (e.g., database 350) each can be implemented using any suitable manner of wired and/or wireless communication. Accordingly, system 300 and/or collection expanding system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 300 and/or collection expanding system 310 can retrieve, automatically or in response to a user request received from user 330 via user device 320 through network 340, a target collection of one or more collections from database 350. The target collection can comprise: collection items (e.g., furniture items or apparels), one or more collection styles, and/or one or more collection colors. System 300 and/or collection expanding system 310 also can determine candidate items for possibly expanding the target collection, and the candidate items can be determined based at least in part on the collection items of the target collection. For example, system 300 and/or collection expanding system 310 can initially use complementary candidate items and/or substitute candidate items based on the collection items of the target collection as the candidate items.

In some embodiments, complementary candidate items can be items from the item database that are functionally complementary to the collection items (e.g., office chairs and desks, couches and coffee tables, etc.). System 300 and/or collection expanding system 310 can determine a likelihood score of complementary signals associated with a candidate item and each of the collection items of the target collection, based at least in part on at least one of: (a) one or more view-also-viewed acts by one or more consumers (e.g., occurrences of when the consumers viewed a collection item (x) and then viewed the candidate item (y) as well in one visit to the system, or vice versa); or (b) one or more view-ultimately-bought acts by the one or more consumers (e.g., occurrences of when the consumers purchased a collection item (x) and the candidate item (y) together in a transaction, or vice versa). When the likelihood of complementary signals is at least as great as a predetermined complementary likelihood threshold, system 300 and/or collection expanding system 310 can add the candidate item to the one or more complementary candidate items.

In certain embodiments, substitute candidate items can be visually similar or identical to the collection items (e.g., with similar or identical shapes, colors, finishes, materials, etc.). System 300 and/or collection expanding system 310 can determine the one or more substitute candidate items for the collection items based at least in part on a visual similarity matrix, the visual similarity matrix comprising a respective visual similarity score between each of the one or more substitute candidate items and each of the collection items. In some embodiments, system 300 and/or collection expanding system 310 can comprise image processing capabilities, such as object detection or recognition based on various techniques and models know in the art, to identify and extract the respective item portions, and their respective attributes, in the item images before calculating the respective visual similarity score based on the item portions and attributes, as extracted.

In a number of embodiments, system 300 and/or collection expanding system 310 can add a predetermined count of top substitute candidates of the one or more substitute candidate items to the candidate items, in which the top substitute candidates can be determined based on a respective maximum visual similarity score of the respective visual similarity scores in the visual similarity matrix for each of the one or more substitute candidate items. For instance, system 300 and/or collection expanding system 310 can allow a top 10, 12, or 20 candidate items for the collection items determined based on their respective visual similarity scores. In several embodiments, system 300 and/or collection expanding system 310 can allow a top 3 respective visually similar items for each of the collection items as candidate items (e.g., total 3×N candidate items determined based on visual similarity, where N is the count of the collection items).

After determining an initial group of candidate items, system 300 and/or collection expanding system 310 also can filter items that do not match one or more concepts of the target collection (e.g., style(s) or color(s)) out of the candidate items. In some embodiments, system 300 and/or collection expanding system 310 can determine that a first candidate item does not match the concepts of the target collection and can thus remove the first candidate item from the candidate items when at least one of: (a) at least a dominant style of the first candidate item is not included in the one or more collection styles of the target collection; or (b) at least a dominant color of the first candidate item is not included in the one or more collection colors.

In some embodiments, system 300 and/or collection expanding system 310 can automatically extract one or more of: (a) the concept values for each item; (b) a predetermined number of representative collection styles for each collection; and/or (c) a predetermined number of representative collection colors for each collection, etc. In many embodiments, system 300 and/or collection expanding system 310 can be configured to automatically determine the concept value(s) of an item for one or more of the concepts: shape(s); pattern(s); finish(es); material(s); color(s); and/or upholstery, based at least in part on the item image(s) and/or the item description(s) of the item. For example, system 300 and/or collection expanding system 310 can determine the color value(s) for an item based at least in part on the pixels of the item image(s) of the item. Additionally, system 300 and/or collection expanding system 310 can determine that the style value(s) for an item includes “Bohemian” when the color value(s) is of a more vibrant and intense color (e.g., red, or purple) and/or when the item description includes the word “Bohemian” or “Boho.” In certain embodiments, system 300 and/or collection expanding system 310 also can determine one or more dominant colors of an item (e.g., the 2 colors of the most pixels in an item image of the item). In a number of embodiments, system 300 and/or collection expanding system 310 further can determine one or more dominant styles of an item (e.g., the top 3 styles of the 5 styles associated with the item).

In certain embodiments, when the concept values of the collection items in a collection are known, system 300 and/or collection expanding system 310 further can automatically determine a predetermined number of collection styles and/or a predetermined number of collection colors for the collection based on the style values and/or style colors of the collection items. For instance, when 5 out of the 10 collection items in a collection include a style value, “casual,” 4 out of the 10 collection items include a style value, “rustic farmhouse,” and no other style values are associated with more than 4 collection items, system 300 and/or collection expanding system 310 can determine that the 2 representative collection styles are “casual” and “rustic farmhouse.” In a number of embodiments, the predetermined number of representative collection colors and/or the predetermined number of representative collection colors for a collection can be determined based on the initial collection items of the collection, when the collection is created and/or curated, and remain so even after the collection is later expanded. In some embodiments, the predetermined number of representative collection colors and/or the predetermined number of representative collection colors for a collection can be updated after the collection is expanded.

In a number of embodiments, system 300 and/or collection expanding system 310 further can remove a second candidate item from the candidate items when a maximum concept similarity score for the second candidate item is less than a predetermined concept threshold. In certain embodiments, the maximum concept similarity score for the second candidate item can be determined based at least in part on a respective weighted average score among each pair of one or more concept values of the second candidate item and one or more respective concept values of each of the collection items. For example, when a second candidate item can comprise a concept value vector of concept values: {(concept_{c2-1}, value_{c2-1}), (concept_{c2-2}, value_{c2-2}), (concept_{c2-3}, value_{c2-3}), . . . (concept_{c2-k}, value_{c2-k})}, and a collection item (ti) of the target collection can comprise a concept value vector of concept values: {(conceptₜᵢ₋₁, valueₜᵢ₋₁), (conceptₜᵢ₋₂, valueₜᵢ₋₂), (conceptₜᵢ₋₃, valueₜᵢ₋₃), . . . (conceptₜᵢ₋ₖ, valueₜᵢ₋ₖ)}, a concept similarity score can be a weighted sum of the distance (d) between each pair of concept values, Σ_{0<n<=k} (wₙ*d(value_{c2-n}, valueₜᵢ₋ₙ)), wherein wₙ is a predetermined weight value for the n-th concept value of the k concepts.

In some embodiments, a concept value can be assigned a numerical value or further comprise a vector of numerical values, and accordingly, the concept similarity score can be calculated directly by mathematical operations. In similar or different embodiments, a concept value can be selected from or categorized as one of multiple categories of a predefined closed list, and the distance between two concept values can be predefined as well. For instance, a color value can be selected from “red,” “blue,” “yellow,” “white,” or “black,” the distance between “red” and “blue” is 5, the distance between “red” and “yellow” is 3, and so on. The numerical concept value(s), the distance and/or difference between each pair of concept values, and/or the weight (w) given to each concept value can be defined by the administrator of 300 and/or collection expanding system 310 and/or constantly updated by a machine leaning system based on feedbacks from other systems (e.g., system 300 or collection expanding system 310) and/or user 330.

After determining the candidate items, system 300 and/or collection expanding system 310 can expand the target collection by adding the candidate items to the target collection and storing the target collection to the database. In some embodiments, system 300 and/or collection expanding system 310 further can notify user 330, via user device 320 through network 340, about the candidate items identified or the target collection, as expanded, either before or after storing the target collection, and allow user 330 to approve or revoke such expansion. In embodiments with one or more of machine learning systems or modules, the approval or revocation of the candidate items by user 330 can be provided as a feedback to the machine leaning system(s) or module(s).

In some embodiments, system 300 and/or collection expanding system 310 also can include one or more machine learning systems or modules configured to fine tune the methods of determining view-also-viewed acts, view-ultimately-bought acts, the distance between two concept values, and/or the visual similarity score between two items, etc. In many embodiments, system 300 and/or collection expanding system 310 can expand a target collection, or present the recommendations to user 330, in real-time so that user 330 can publish the curated collections regularly.

Conventional systems are unable to automatically expand a collection of items with one or more candidate items, other than to recommend or search for similar or complementary items, because conventional systems typically lack the ability to at least determine whether a candidate item matches the overall colors/styles of the collection. In many embodiments, concept extraction techniques provided by system 300 and/or collection expanding system 310 can advantageously address the problem by extracting concept values of the candidate item and each of the collection items and determining the collection style(s) and/or color(s) and can match the candidate item with the collection by comparing the concept values of the candidate item, as extracted, and the collection style(s) and/or color(s).

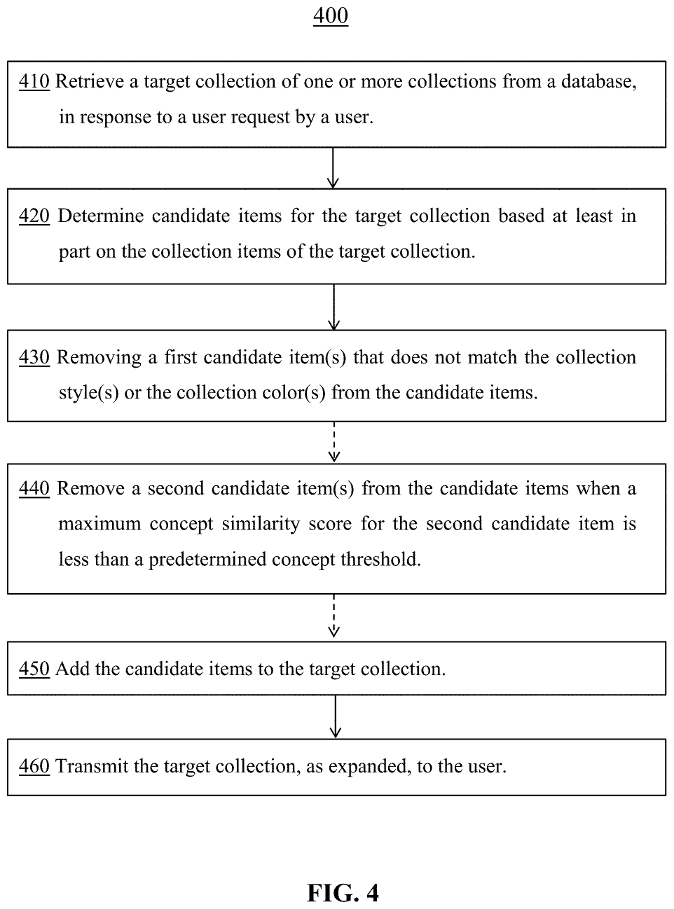

Turning ahead in the drawings, FIG. 4 illustrates a method 400 of automatically expanding a target collection with collection items, according to another embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) and/or collection expanding system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300 (FIG. 3) and/or collection expanding system 310 (FIG. 3). The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include a block 410 of retrieving a target collection of one or more collections from a database (e.g., database 350 (FIG. 3)). Method 400 also can include receiving, before retrieving the target collection, a user request by a user (e.g., user 330 (FIG. 3)) via a user device (e.g. user device 320 (FIG. 3)) through a network (e.g., network 340 (FIG. 3)). In some embodiments, the user request can include a command to expand the target collection and the target collection.

Method 400 further can include a block 420 of determining candidate items for the target collection based at least in part on the collection items of the target collection. The target collection can be created or originally maintained by a user (e.g., user 330 (FIG. 3)) and/or a system (e.g., system 300 (FIG. 3), collection expanded system 310 (FIG. 3), etc.). The collection items can have respective attribute or concept values (e.g., shapes, styles, colors, patterns, finishes, materials, upholstery, etc.). The collection items of the target collection also can have matching (complementary, similar, or identical) style(s), color(s), pattern(s), material(s), and so forth, and the target collection can thus have representative and/or dominant style(s) and/or color(s) determined based on the concept values of the collection items. Block 420 additionally can include determining the candidate items initially from one or more complementary candidate items, and/or one or more substitute candidate items, etc.

Method 400 also can include a block 430 of removing a first candidate item(s) that does not match the collection style(s) or the collection color(s) from the candidate items. For example, for a first candidate item with dominant styles of “Zen” and “Contemporary” and dominant colors of beige, baby blue, and gray, block 430 can determine that the first candidate item does not match the collection styles or the collection colors when “Zen” is not included in the collection styles or gray is not included in the collection colors. Block 430 also can determine that the first candidate item does not match the collection styles or the collection colors when neither of the dominant styles of the first candidate item is included in the collection styles and/or none of the dominant colors of the first candidate item is included in the collection colors.

Method 400 optionally can include a block 440 of removing a second candidate item(s) from the candidate items when a maximum concept similarity score for the second candidate item(s) is less than a predetermined concept threshold. Method 400 can include extracting respective concept values for the second candidate item(s) and the collection items. In some embodiments, extracting the respective concepts of an item (e.g., the second candidate item(s) or each of the collection items) can be performed when the item is added to a database (e.g., database 350 (FIG. 3)). In certain embodiments, extracting the respective concepts can be performed in real-time prior to determining a concept similarity score. Method 400 also can include determining the maximum concept similarity score for the second candidate item(s) based on a respective concept similarity score between the second candidate item(s) and each of the collection items.

Method 400 additionally can include a block 450 of adding the candidate items to the target collection. The target collection can be stored in a volatile memory and can be persisted to a permanent storage.

Method 400 finally can include a block 460 of transmitting the target collection, as expanded, to the user. As an example, the transmitting can include transmitting instructions to display the target collection on a user interface of an electronic device, so that the user can review the target collection. In some embodiments, method 400 also can include waiting for the approval of the user before storing and/or updating the target collection back to the database.

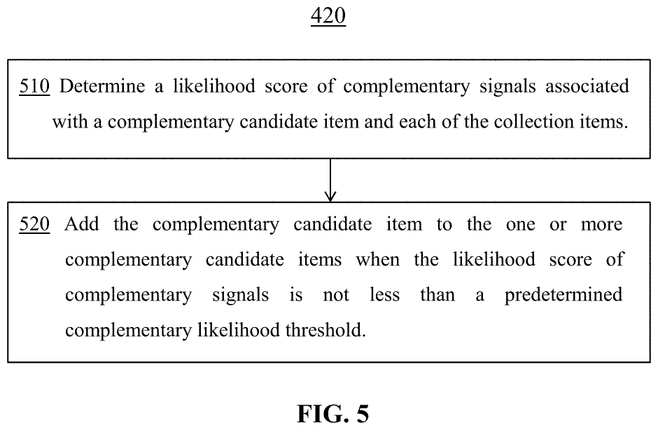

Turning ahead in the drawings, FIG. 5 illustrates a flow chart for performing a portion of block 420 of determining one or more complementary items as candidate items for the collection items of the target collection, according to the embodiment of FIG. 4. Block 420 is merely exemplary and is not limited to the embodiments presented herein. Block 420 can be employed in many different embodiments or examples not specifically depicted or described herein. In some embodiments, the procedures, the processes, and/or the activities of block 420 can be performed in the order presented. In other embodiments, the procedures, the processes, and/or the activities of block 420 can be performed in any suitable order. In still other embodiments, one or more of the procedures, the processes, and/or the activities of block 420 can be combined or skipped.

In many embodiments, system 300 (FIG. 3) and/or collection expanding system 310 (FIG. 3) can be suitable to perform block 420 and/or one or more of the activities of block 420. In these or other embodiments, one or more of the activities of block 420 can be implemented as one or more computing instructions configured to run at one or more processors and configured to be stored at one or more non-transitory computer readable media. Such non-transitory computer readable media can be part of system 300 (FIG. 3) and/or collection expanding system 310 (FIG. 3). The processor(s) can be similar or identical to the processor(s) described above with respect to computer system 100 (FIG. 1).

In some embodiments, block 420 and other blocks in block 420 can include using a distributed network including distributed memory architecture to perform the associated activity. This distributed architecture can reduce the impact on the network and system resources to reduce congestion in bottlenecks while still allowing data to be accessible from a central location.

Referring to FIG. 5, block 420 can include a block 510 of determining a likelihood score of complementary signals associated with a complementary candidate item and each of the collection items. In some embodiments, complementary signals can include one or more acts by consumers, including view-and-viewed acts, view-ultimately-bought acts, etc. Block 420 also can include determining the complementary signals to be adopted for determining the likelihood score by machine learning. For example, block 420 can determine that two items viewed one after the other should have a higher likelihood score than other viewing relationships.

Block 420 further can include a block 520 of adding the complementary candidate item to the one or more complementary candidate items when the likelihood score of complementary signals is not less than a predetermined complementary likelihood threshold.

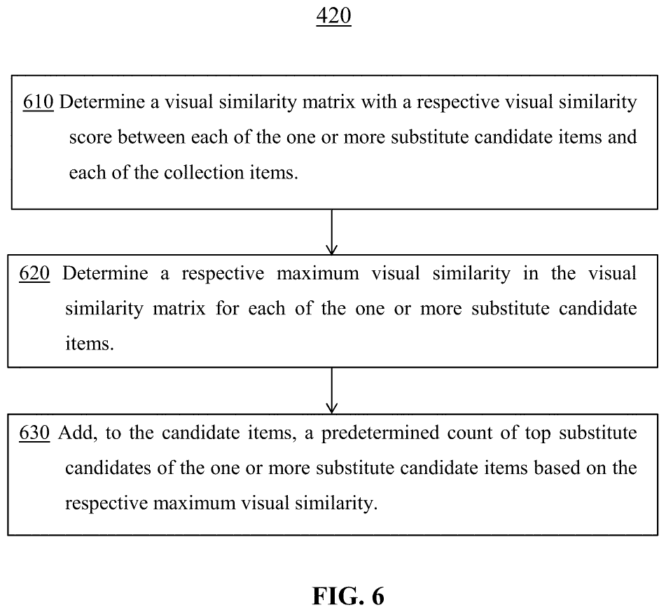

Turning ahead in the drawings, FIG. 6 illustrates a flow chart for performing another portion of block 420 of determining one or more substitute items as candidate items for the collection items of the target collection, according to the embodiment of FIG. 4. Block 420 is merely exemplary and is not limited to the embodiments presented herein. Block 420 can be employed in many different embodiments or examples not specifically depicted or described herein. In some embodiments, the procedures, the processes, and/or the activities of block 420 can be performed in the order presented. In other embodiments, the procedures, the processes, and/or the activities of block 420 can be performed in any suitable order. In still other embodiments, one or more of the procedures, the processes, and/or the activities of block 420 can be combined or skipped.

In many embodiments, system 300 (FIG. 3) and/or collection expanding system 310 (FIG. 3) can be suitable to perform block 420 and/or one or more of the activities of block 420. In these or other embodiments, one or more of the activities of block 420 can be implemented as one or more computing instructions configured to run at one or more processors and configured to be stored at one or more non-transitory computer readable media. Such non-transitory computer readable media can be part of system 300 (FIG. 3) and/or collection expanding system 310 (FIG. 3). The processor(s) can be similar or identical to the processor(s) described above with respect to computer system 100 (FIG. 1).

In some embodiments, block 420 and other blocks in block 420 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, block 420 can include a block 610 of determining a visual similarity matrix with a respective visual similarity score between each of the one or more substitute candidate items and each of the collection items. The respective visual similarity score can be determined whenever a new item is added to the database. In some embodiments, block 420 can include various search techniques (e.g., nearest neighbor search (NNS), etc.) to determine visually similar “neighbors” in real-time and calculate the respective visual similarity score between a collection item and any neighboring substitute candidate item. If a substitute candidate item is a neighbor to a first collection item but not to a second collection item, block 420 can assign zero to the respective visual similarity score between the substitute candidate item and the second collection item. In a number of embodiments, block 420 can determine a respective visual similarity vector for each of the collection items, wherein the respective visual similarity vector comprises a respective visual similarity score between the each of the collection items and its neighboring substitute candidate item(s).

Block 420 further can include a block 620 of determining a respective maximum visual similarity in the visual similarity matrix for each of the one or more substitute candidate items.

Block 420 also can include a block 630 of adding, to the candidate items, a predetermined count of top substitute candidates of the one or more substitute candidate items based on the respective maximum visual similarity.

In many embodiments, the techniques described herein can provide a practical application and several technological improvements. In some embodiments, the techniques described herein can provide for automatically expanding a curated collection of items. These techniques described herein can provide a significant improvement over conventional approaches of recommending complementary or similar items based on a single item and overlooking the overall colors and/or styles of the collection.

In many embodiments, the techniques described herein can beneficially generate a collection expanding model which can be used to add matching products (e.g., complementary or substitute products in terms of styles, colors, etc.), or to present recommendations for matching products to be added, to a curated collection initially comprising a few products. In many embodiments, the techniques described herein can be used in real-time at a scale that cannot be handled using manual techniques. For example, the number of unique items can be over tens or hundreds of thousands or even millions and grow rapidly, and a curator (e.g., user 330 (FIG. 3), an influencer, or a marketing professional) may create or curate a new collection weekly, if not daily, to maintain followers.

In a number of embodiments, the techniques described herein can solve a technical problem that arises only within the realm of computer networks, as online ordering do not exist outside the realm of computer networks. Moreover, the techniques described herein can solve a technical problem that cannot be solved outside the context of computer networks. Specifically, the techniques described herein cannot be used outside the context of computer networks, in view of a lack of data.

Various embodiments can include a system including one or more processors and one or more non-transitory computer-readable media storing computing instructions configured to run on the one more processors and perform certain acts. The acts can include upon receiving a user request from a user via a user device through a network, retrieving a target collection of one or more collections from a database. The target collection can comprise: collection items; one or more collection styles; and one or more collection colors. The acts also can include determining candidate items for the target collection based at least in part on the collection items of the target collection. The candidate items can comprise one or more complementary candidate items or one or more substitute candidate items, etc.

The acts further can include remove a first candidate item of the candidate items from the candidate items when at least one of: (a) at least a dominant style of the first candidate item is not included in the one or more collection styles; or (b) at least a dominant color of the first candidate item is not included in the one or more collection colors. The acts additionally can include adding the candidate items to the target collection. The acts also can include transmitting, through the network, the target collection, as expanded, to the user via the user device.

A number of embodiments can include a method being implemented via execution of computing instructions configured to run at one or more processors and stored at one or more non-transitory computer-readable media. The method can include upon receiving a user request from a user via a user device through a network, retrieving a target collection of one or more collections from a database. The target collection can comprise: (a) collection items; (b) one or more collection styles; and (c) one or more collection colors.

The method further can include determining candidate items for the target collection based at least in part on the collection items of the target collection. The candidate items can comprise at least one of: one or more complementary candidate items; or one or more substitute candidate items. The method also can include removing a first candidate item of the candidate items from the candidate items when at least one of: (a) at least a dominant style of the first candidate item is not included in the one or more collection styles; or (b) at least a dominant color of the first candidate item is not included in the one or more collection colors. The method also can include adding the candidate items to the target collection. The method additionally can include transmitting, through the network, the target collection to be presented to the user via the user device.

Although the methods described above are with reference to the illustrated flowcharts, it will be appreciated that many other ways of performing the acts associated with the methods can be used. For example, the order of some operations may be changed, and some of the operations described may be optional, skipped or altered.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically expanding a curated collection of items has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 4-6 may include different procedures, processes, and/or activities and be performed by many different modules, in many different orders. As another example, one or more of the procedures, processes, and/or activities of one of FIGS. 4-6 can be performed in another one of FIGS. 4-6. As another example, the systems and/or subsystems within system 300 or collection expanding system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
upon receiving a user request from a user via a user device through a network, retrieving a target collection of one or more collections from a database, wherein:
the target collection comprises:
collection items;
one or more collection styles; and
one or more collection colors;
determining candidate items for the target collection based at least in part on the collection items of the target collection, wherein the candidate items comprise at least one of:
one or more complementary candidate items; or
one or more substitute candidate items;
removing a first candidate item of the candidate items from the candidate items when at least one of:
at least a dominant style of the first candidate item is not included in the one or more collection styles; or
at least a dominant color of the first candidate item is not included in the one or more collection colors;
adding the candidate items to the target collection; and
transmitting, through the network, the target collection to be presented to the user via the user device.

2. The system in claim 1, wherein:
each of the collection items of the target collection comprises a respective item type of one or more item types;
each of the one or more item types is associated with one or more respective item-type concepts; and
each of the collection items comprises one or more respective concept values for one or more respective item-type concepts associated with a respective item type of the each of the collection items.

3. The system in claim 2, wherein:
the computing instructions are further configured to perform:
prior to adding the candidate items to the target collection:
determining a maximum concept similarity score for a second candidate item of the candidate items based at least in part on a respective weighted average score among each pair of one or more concept values of the second candidate item and one or more respective concept values of each of the collection items; and
removing the second candidate item of the candidate items from the candidate items when the maximum concept similarity score for the second candidate item is less than a predetermined concept threshold.

4. The system in claim 2, wherein:
the computing instructions are further configured to perform:
automatically extracting the one or more respective concept values based at least in part on a respective item image and a respective item description of the each of the collection items.

5. The system in claim 2, wherein:
each of the one or more respective item-type concepts is one of:
a shape;
a pattern;
a finish;
a material;
a color; or
an upholstery.

6. The system in claim 1, wherein:
the computing instructions are further configured to perform:
determining a likelihood score of complementary signals associated with a candidate item and each of the collection items, based at least in part on at least one of:
one or more view-also-viewed acts by one or more users; or
one or more view-ultimately-bought acts by the one or more users; and
adding the candidate item to the one or more complementary candidate items when the likelihood score of complementary signals is no less than a predetermined complementary likelihood threshold.

7. The system in claim 1, wherein:
the computing instructions are further configured to perform:
determining the one or more substitute candidate items for the collection items based at least in part on a visual similarity matrix, the visual similarity matrix comprising a respective visual similarity score between each of the one or more substitute candidate items and each of the collection items.

8. The system in claim 7, wherein:
the computing instructions are further configured to perform:
determining a respective maximum visual similarity score in the visual similarity matrix for each of the one or more substitute candidate items; and
adding, to the candidate items, a predetermined count of top substitute candidates of the one or more substitute candidate items based on the respective maximum visual similarity score.

9. The system in claim 1, wherein:
the computing instructions are further configured to perform:
extracting automatically one or more respective dominant colors of each of the candidate items based at least in part on pixels of a respective candidate image of the each of the candidate items.

10. The system in claim 1, wherein:
each of the candidate items further comprises a respective item image, a respective item description, and one or more respective dominant styles; and
the one or more respective dominant styles are determined based on the respective item image and the respective item description of the each of the candidate items.

11. A method being implemented via execution of computing instructions configured to run at one or more processors and stored at one or more non-transitory computer-readable media, the method comprising:
upon receiving a user request from a user via a user device through a network, retrieving a target collection of one or more collections from a database, wherein:
the target collection comprises:
collection items;
one or more collection styles; and
one or more collection colors;
determining candidate items for the target collection based at least in part on the collection items of the target collection, wherein the candidate items comprise at least one of:
one or more complementary candidate items; or
one or more substitute candidate items;
removing a first candidate item of the candidate items from the candidate items when at least one of:
at least a dominant style of the first candidate item is not included in the one or more collection styles; or
at least a dominant color of the first candidate item is not included in the one or more collection colors;
adding the candidate items to the target collection; and
transmitting, through the network, the target collection to be presented to the user via the user device.

12. The method in claim 11, wherein:
each of the collection items of the target collection comprises a respective item type of one or more item types;
each of the one or more item types is associated with one or more respective item-type concepts; and
each of the collection items comprises one or more respective concept values for one or more respective item-type concepts associated with a respective item type of the each of the collection items.

13. The method in claim 12 further comprising:
prior to adding the candidate items to the target collection:
determining a maximum concept similarity score for a second candidate item of the candidate items based at least in part on a respective weighted average score among each pair of one or more concept values of the second candidate item and one or more respective concept values of each of the collection items; and
removing the second candidate item of the candidate items from the candidate items when the maximum concept similarity score for the second candidate item is less than a predetermined concept threshold.

14. The method in claim 12 further comprising:
automatically extracting the one or more respective concept values based at least in part on a respective item image and a respective item description of the each of the collection items.

15. The method in claim 12, wherein:
each of the one or more respective item-type concepts is one of:
a shape;
a pattern;
a finish;
a material;
a color; or
an upholstery.

16. The method in claim 11 further comprising:
determining a likelihood score of complementary signals associated with a candidate item and each of the collection items, based at least in part on at least one of:
one or more view-also-viewed acts by one or more users; or
one or more view-ultimately-bought acts by the one or more users; and
adding the candidate item to the one or more complementary candidate items when the likelihood score of complementary signals is no less than a predetermined complementary likelihood threshold.

17. The method in claim 11 further comprising:
determining the one or more substitute candidate items for the collection items based at least in part on a visual similarity matrix, the visual similarity matrix comprising a respective visual similarity score between each of the one or more substitute candidate items and each of the collection items.

18. The method in claim 17 further comprising:
determining a respective maximum visual similarity score in the visual similarity matrix for each of the one or more substitute candidate items; and
adding, to the candidate items, a predetermined count of top substitute candidates of the one or more substitute candidate items based on the respective maximum visual similarity score.

19. The method in claim 11 further comprising:
extracting automatically one or more respective dominant colors of each of the candidate items based at least in part on pixels of a respective candidate image of the each of the candidate items.

20. The method in claim 11, wherein:
each of the candidate items further comprises a respective item image, a respective item description, and one or more respective dominant styles; and
the one or more respective dominant styles are determined based on the respective item image and the respective item description of the each of the candidate items.
